(19) United States
(12) Patent Application Publication
(10) Pub. No.: US 2025/0234242 A1
(43) Pub. Date: Jul. 17, 2025

(54) SYSTEMS AND METHODS FOR COMMUNICATIONS WITH EXPEDITED DATA TRANSFER

(71) Applicant: Meta Platforms Technologies, LLC, Menlo Park, CA (US)

(72) Inventors: Curt Wong, Bellevue, WA (US); Zhu Ji, Cupertino, CA (US); Liwen Yu, Santa Clara, CA (US); Xiaodi Zhang, San Ramon, CA (US)

(73) Assignee: Meta Platforms Technologies, LLC, Menlo Park, CA (US)

(21) Appl. No.: 18/978,782

(22) Filed: Dec. 12, 2024

Related U.S. Application Data
(60) Provisional application No. 63/620,016, filed on Jan. 11, 2024.

(51) Int. Cl. H04W 28/02; H04L 47/2416; H04L 47/762

(52) U.S. Cl. CPC H04W 28/0268; H04L 47/2416; H04L 47/762

(57) ABSTRACT

Systems and methods for communications with expedited data transfer may include an application server which is configured to determine a payload is to be sent uplink from a user device to the application server. The application server may send, via a transmitter to a wireless communication node, a signal to cause the wireless communication node to trigger a reflective quality of service (QOS) procedure by the user device for transmitting the payload to the application server. The application server may receive, via a receiver from the user device, one or more packets including the payload according to the reflective QoS procedure.

### CROSS-REFERENCE TO RELATED APPLICATION

This application claims the benefit of and priority to U.S. Provisional Application No. 63/620,016, filed Jan. 11, 2024, the contents of which are incorporated herein by reference in its entirety.

### FIELD OF DISCLOSURE

The present disclosure is generally related to wireless communication between devices, including but not limited to, systems and methods for wireless communications with expedited data transfers.

### BACKGROUND

Augmented reality (AR), virtual reality (VR), and mixed reality (MR) are becoming more prevalent, which such technology being supported across a wider variety of platforms and device. Some devices may be supported through cellular communications.

### SUMMARY

In one aspect, this disclosure relates to a method. The method may include determining, by an application server, a payload is to be sent uplink from a user device to the application server. The method may include sending, by the application server to a wireless communication node, a signal to cause the wireless communication node to trigger a reflective quality of service (QoS) procedure by the user device for transmitting the payload to the application server. The method may include receiving, by the application server, from the user device via the wireless communication node, one or more packets including the payload according to the reflective QoS procedure.

In some embodiments, the signal includes an internet protocol (IP) packet carrying an indication to trigger the reflective QoS procedure. In some embodiments, the signal causes the wireless communication node to configure a 5G QOS indicator (5QI) value via a user plane function (UPF) for a downlink channel, to cause the user device to use the 5QI value for transmitting the one or more packets including the payload uplink, according to the reflective QoS procedure. In some embodiments, the one or more packets include one or more second packets. The method may further include receiving, by the application server from the user device, a first packet according to a first 5G QoS indicator (5QI) value. In some embodiments, the application server determines that the payload is to be sent uplink from the user device according to the first packet. In some embodiments, the first 5QI value is different than a second 5QI value triggered by the wireless communication node according to the reflective QoS procedure and in which the application server receives the one or more second packets.

In some embodiments, the application server determines that the user device is to send the payload uplink to the application server, according to an application running on the user device and supported by the application server. In some embodiments, the application supports real-time information transmission from the user device to the application server. In some embodiments, the signal includes a binary indicator indicating to trigger the reflective QoS procedure, according to a value of the binary indicator.

In another aspect, this disclosure relates to a system including an application server including one or more processors configured to determine a payload is to be sent uplink from a user device to the application server. The one or more processors may be configured to send, via a transmitter to a wireless communication node, a signal to cause the wireless communication node to trigger a reflective quality of service (QOS) procedure by the user device for transmitting the payload to the application server. The one or more processors may be configured to receive, via a receiver from the user device, one or more packets including the payload according to the reflective QoS procedure.

In some embodiments, the signal includes an internet protocol (IP) packet carrying an indication to trigger the reflective QoS procedure. In some embodiments, the signal causes the wireless communication node to configure a 5G QoS indicator (5QI) value via a user plane function (UPF) for a downlink channel, to cause the user device to use the 5QI value for transmitting the one or more packets including the payload uplink, according to the reflective QoS procedure. In some embodiments, the one or more packets include one or more second packets. The one or more processors may be configured to receive, via the receiver from the user device, a first packet according to a first 5G QoS indicator (5QI) value. In some embodiments, the application server determines that the payload is to be sent uplink from the user device according to the first packet. In some embodiments, the first 5QI value is different than a second 5QI value triggered by the wireless communication node according to the reflective QoS procedure and in which the application server receives the one or more second packets.

In some embodiments, the one or more processors are configured to determine that the user device is to send the payload uplink to the application server, according to an application running on the user device and supported by the application server. In some embodiments, the application supports real-time information transmission from the user device to the application server. In some embodiments, the signal includes a binary indicator indicating to trigger the reflective QoS procedure, according to a value of the binary indicator.

In yet another aspect, this disclosure relates to a non-transitory computer readable medium storing instructions that, when executed by one or more processors of an application server, cause the application server to determine a payload is to be sent uplink from a user device to the application server. The instructions may further cause the application server to send, via a transmitter to a wireless communication node, a signal to cause the wireless communication node to trigger a reflective quality of service (QOS) procedure by the user device for transmitting the payload to the application server. The instructions may further cause the application server to receive, via a receiver from the user device, one or more packets including the payload according to the reflective QoS procedure.

In some embodiments, the signal causes the wireless communication node to configure a 5G QoS indicator (5QI) value via a user plane function (UPF) for a downlink channel, to cause the user device to use the 5QI value for transmitting the one or more packets including the payload uplink, according to the reflective QoS procedure.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for communication with expedited data transfer, according to an example implementation of the present disclosure.

FIG. 6 is a network diagram, according to an example implementation of the present disclosure.

FIG. 7 is a diagram showing a process flow of communication with expedited data transfer, according to an example implementation of the present disclosure.

FIG. 8 is a flowchart showing an example method for communication with expedited data transfer, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

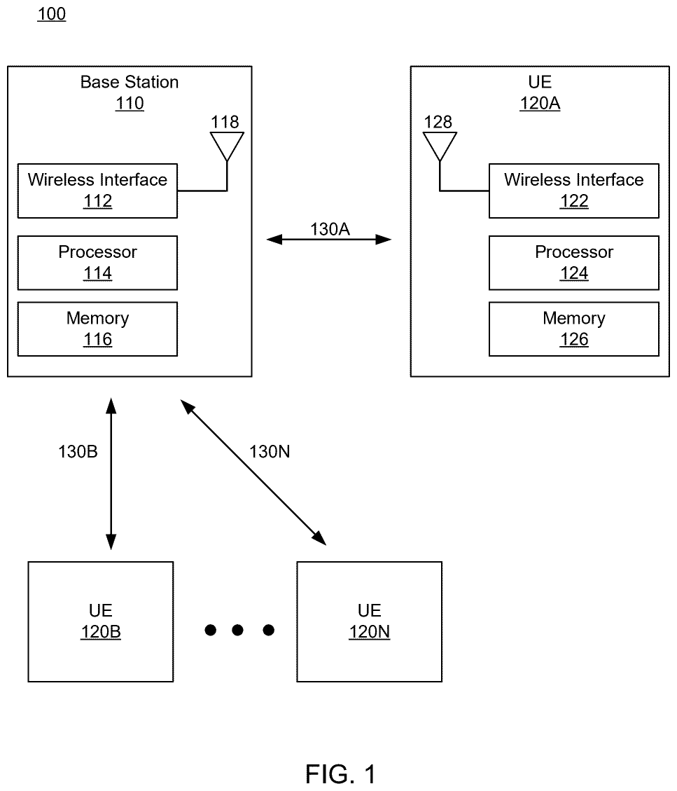

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

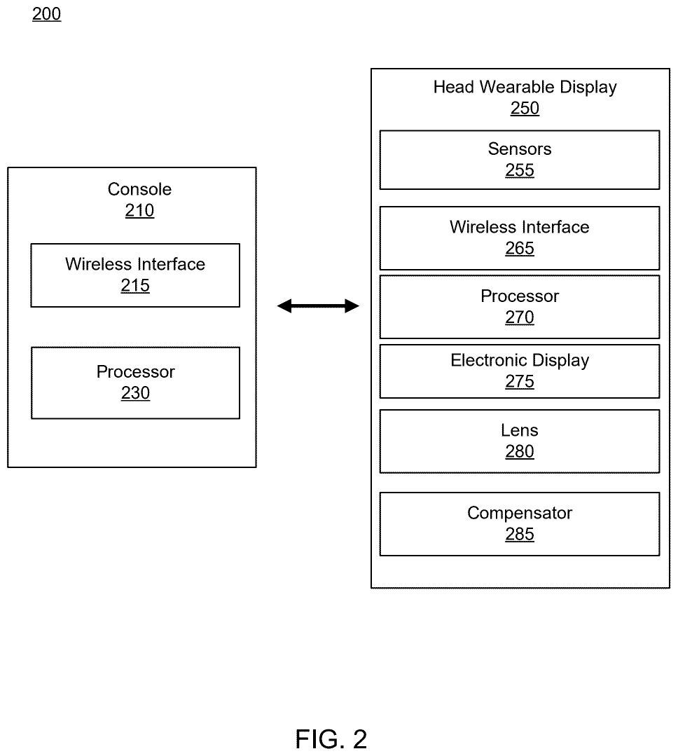

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is-10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

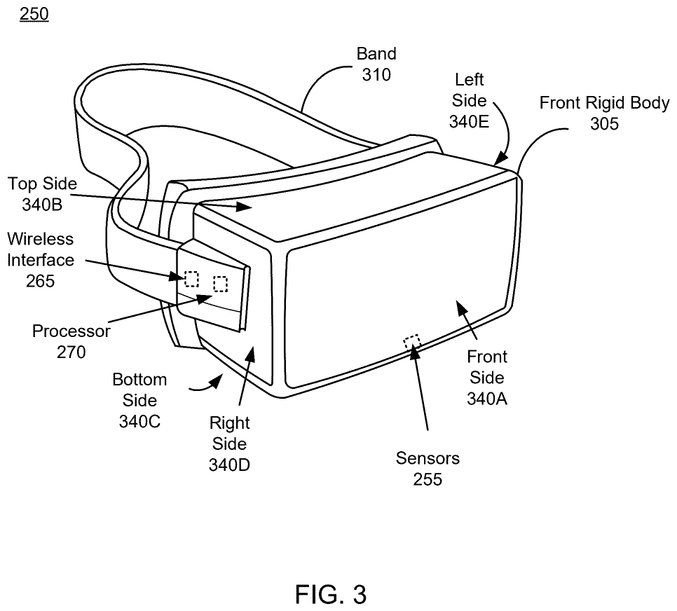

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

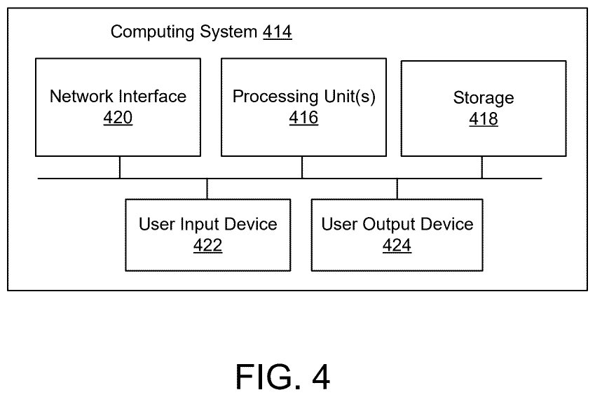

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

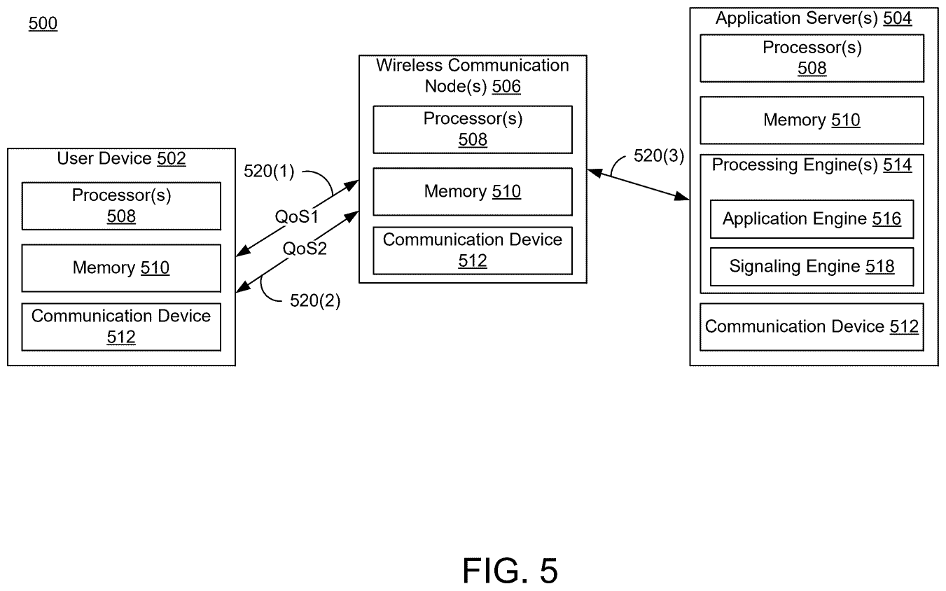

Referring generally to FIG. 5-FIG. 8, for various communications via a wireless network, such as communication supporting multi-modality artificial intelligence (MM AI), a traffic pattern may involve a device sending (e.g., to an endpoint or server via a cellular connection or channel) a picture/video (2 MB file), a short speech (100 KB file), and/or locality information like geolocation/temperature/time (10 kB file). In other cases, the traffic pattern may only contain speech and locality information. Accordingly, since the uplink (UL) traffic size and pattern can vary based on application demand, using a guaranteed bit rate (GBR) communication channel or link may not be efficient from the cellular network system perspective (e.g., how much radio bandwidth to reserve and how long to reserve it for, etc.). However, using non-GBR communication channels or links may cause unpredictable delays, latency, and packet drop, due to—for example—sending a large file (e.g., 2 MB with higher resolution jpeg/video) uplink to the server or endpoint, in some cases.

Some solutions may define a 5GS Reflective quality of service (QOS) feature. The systems and methods described herein may trigger the Reflective QOS feature via an application server request, based on application requirements. By an application server sending a request (e.g., to the network) to trigger a reflective QoS at the network with an improved QoS channel (e.g., relative to one currently being used by a UE for sending other UL traffic to the application server), the network may temporarily assign a communication channel or link with improved QOS metrics (e.g., via a better 5G QoS indicator (5QI) value, based on the request from the application server, for both uplink (UL) and downlink (DL) traffic of a particular application. The server or endpoint may be configured to request this feature from 5GS when the application is to cause the user device to send more additional information for increased payload and time-sensitive communications (e.g., a short video clip, geolocation information, or other information which is to be used for real-time analysis). Hence, better radio resources may only be requested when necessary for supporting a particular application.

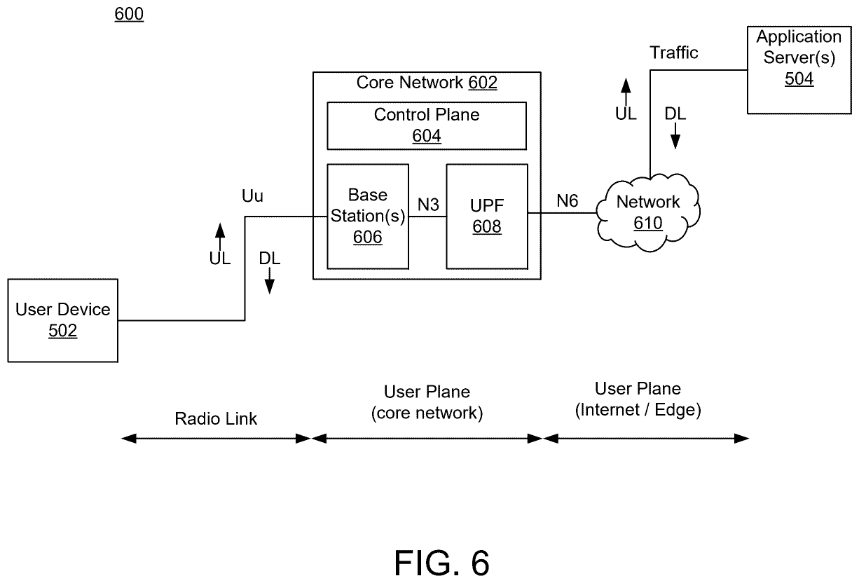

Referring now to FIG. 5, depicted is a block diagram of a system 500 for communication with expedited data transfer, according to an example implementation of the present disclosure. The system may include a user device 502 communicably coupled to an application server 504 via one or more wireless communication nodes 506. The user device 502 may be similar to the user equipment 120, console 210, and/or head wearable display 250 described above with reference to FIG. 1-FIG. 4. The wireless communication node(s) 506 may be the same as or similar to the base station 110 described above with reference to FIG. 1, or one or more of the components described below in FIG. 6. The application server 504 may be or include any server which hosts, provisions, provides, supports, or is otherwise associated with one or more applications executable on the user device 502. For example, the application server 504 may be associated with a location-based application (e.g., location services, navigation services, etc.), a real-time augmented reality analysis and provisioning application (e.g., analyzing an environment of the user device 502 to provide information related thereto), or any other application which may leverage real-time information from the user device 502 (e.g., either alone or in combination with non-real-time information). In some embodiments, the application supported by the application server 504 may be or include a multi-modality artificial intelligence (MM AI) application which analyzes multi-modality information from the user device 502 as part of providing AI services.

As described in greater detail below, the application server 504 may be configured to determine that a payload is to be sent (e.g., uplink) by the user device 502 to the application server 504. The application server 504 may be configured to send a signal to the wireless communication node(s) 506, which causes the wireless communication node(s) 506 to trigger a reflective quality of service (QOS) procedure by the user device 502 for transmitting the payload to the application server 504. The user device 502 may be configured to transmit, and correspondingly the application server 504 may be configured to receive, one or more packets including the payload according to the reflective QoS procedure.

According to the systems and methods described herein, by sending the signal to the wireless communication node 506 which triggers the reflective QoS procedure by the user device 502, the systems and methods described herein may implement an expedited data transfer of time sensitive information (e.g., the payload) temporarily and on-demand, without having to continuously use better QoS bit pipes/communication channels/communication links, thereby increasing the efficiency of network resources allocated by the network. For example, the user device 502 can use a first communication channel (e.g., according to one or more first QoS metrics) for transmission of non-real-time data (e.g., data which may not leverage real-time analysis by the application server 504), and use a second communication channel (e.g., according to one or more second QoS metrics, responsive to the reflective QoS procedure) for transmission of real-time data (e.g., data which leverage real-time analysis by the application server 504).

As shown in FIG. 5, the user device 502, application server 504, and wireless communication node(s) 506 may include one or more processors 508, memory 510, and a communication device 512, respectively. The processor(s) 508 may be the same as or similar to the processors 114, 124, 230, 270 and/or processing unit(s) 416 described above with reference to FIG. 1-FIG. 4. The memory 510 may be the same as or similar to memory 116, 126, and/or storage 418 described above with reference to FIG. 1-FIG. 4. The communication device 512 may be the same as or similar to the wireless interface 112, 122, 215, 265 (e.g., in combination with or communicably coupled to antenna 118, 128) and/or network interface 420 described above with reference to FIG. 1-FIG. 4.

The application server 504 may include one or more processing engines 514. The processing engine(s) 514 may be or include any device, component, element, or hardware designed or configured to perform one or more of the functions described herein. The processing engine(s) 514 may include an application engine 516 and a signaling engine 518. While these processing engine(s) 514 are shown and described herein, it should be understood that additional and/or alternative processing engine(s) 514 may be implemented on the application server 504. Additionally, two or more of the processing engine(s) 514 may be implemented as a single processing engine 514. Furthermore, one of the processing engine(s) 514 may implemented as multiple processing engines 514. Additionally, while shown as included on the application server 504, it is noted that the user device 502 and/or wireless communication node(s) 506 may include, implement, or otherwise incorporate processing engines 514 in addition to the application server 504.

The user device 502, wireless communication node(s) 506, and application server 504 may be communicably coupled to one another via one or more communication links 520. The communication links 520 may be the same as or similar to the wireless communication links 130 described above with reference to FIG. 1. In some embodiments, the communication links 520(1), 520(2) may be established responsive to the user device 502 being in a wireless communication range of the wireless communication node 506 and initiating, e.g., a random access procedure (RAP), to exchange one or more signals between the user device 502 and wireless communication node 506 to access the wireless communication network. For example, the user device 502 may initiate the RAP, responsive to an end user of the user device 502 launching an application corresponding to the application server 504, to use the wireless communication network for exchanging information/data/payloads between the user device 502 and the application server 504.

In some embodiments, as part of the RAP, the user device 502 and wireless communication node 506 may establish a first communication link 520(1) for transmission of data/information/payloads uplink via the wireless communication network to the application server 504. As shown in FIG. 5, one or more communication links 520 may be established between the user device 502 and wireless communication node(s) 506. In various embodiments, the communication links 520 may have different QoS metrics, according to different 5G QoS indicator (5QI) values. For example, different communication links 520 may be used for different types of services, and correspondingly have different QoS metrics for supporting those services. QoS metrics for two non-guaranteed bit rate (GBR) communication links are provided in Table 1 below.

TABLE 1
Example QoS Metrics for Communication Links

| | | Default | Packet | Packet | Default | Default |
|---|---|---|---|---|---|---|
| 5QI | Resource | Priority | Delay | Error | Maximum Data | Averaging |
| value | Type | Level | Budget | Rate | Burst Volume | Window |
| 10 | Non-GBR | 90 | 1100 ms | 10-6 | N/A | N/A |
| 6 | Non-GBR | 60 | 300 ms | 10-6 | N/A | N/A |

In the example shown in Table 1 above, the communication link 520 with a 5QI value of 10 (e.g., first communication link 520(1)) may be used for various example services, such as video services, transmission control protocol (TCP)-based services (e.g., internet services, email services, chat services, file transfer protocol (FTP) services, peer-to-peer (P2P) file sharing, progressive video services), or any other service that can be used over satellite access type with similar characteristics. Additionally, the communication link 520 with a 5QI value of 6 (e.g., second communication link 520(2)) may be used for the same types of services, and additionally for artificial intelligence (AI) or machine learning (ML) model download for image recognition (e.g., for model topography). While these two communication links are represented in Table 1, it should be understood that different communication link(s) 520 may be implemented, with additional varying QoS metrics, other than those provided in Table 1. As illustrated in Table 1, the second communication link 520(1) may have better/stronger/improved QoS metrics relative to the first communication link 520(2) (e.g., by having a better priority level, a reduced packet delay budget, etc.).

The user device 502 may be configured to use the first communication link 502(1) (e.g., a communication link or channel with first QoS metrics) for transmitting various non-real-time information to the application server 504 via the wireless communication node(s) 506. Such implementations improve network resource allocation efficiency by limiting access to higher priority communication links 502(1) to a need-to-use basis. As described in greater detail below, when the application server 504 determines that real-time information/payloads are to be transmitted uplink by the user device 502 to the application server 504, the application server 504 may be configured to transmit a signal to the wireless communication network (e.g., one or more of the wireless communication node(s) 506), to trigger a reflective QoS procedure, which causes the wireless communication node 506 to transmit a packet downlink to the user device 502 via the second communication link 502(2), which is in turn used by the user device 502 for transmitting the real-time information/payload(s) to the application server 504 via the second communication link 502(2) (e.g., with better QoS metrics as compared to the first communication link 502(1)).

Referring now to FIG. 6, depicted is a network diagram 600, according to an example implementation of the present disclosure. As shown in FIG. 6, the network diagram 600 may include the user device 502, application server 504, and core network 602. The core network 602 may include the various wireless communication node(s) 506 intermediary to the user device 502 and application server 504 shown in FIG. 5 and described above. The core network 602 may include a control plane 604, one or more base stations 606, and a user plane function (UPF) 608.

As part of the RAP, the user device 502 may be configured to initiate access to the core network 602 (e.g., for communicating information/data/payloads to the application server 504) based on exchange of signals between the user device 502 and a base station 606 (e.g., the nearest base station 606, base station 606 with strongest received signal strength, etc.) via the Uu interface (e.g., the radio link between user devices 502 base station(s) 606). The control plane 604 may manage signaling and management tasks for the core network 602 (e.g., session establishment, authentication, mobility management, establishing and setting up data sessions, handover between base stations). The UPF 608 may route and process user traffic of the network 610 (e.g., between the user device 502 and application server 504). For example, where uplink traffic is received from the user device 502(via the Uu interface) by the base station 606 via a radio link (e.g., communication link 520), the base station 606 may route the traffic (e.g., via the N3 interface which connects the base station to the UPF 608) to the UPF 608 for routing (e.g., via the N6 interface which connects the UPF 608 to external networks or services) to the network 610. The network 610 may transmit the uplink traffic to the application server 504 (e.g., via the Internet or a direct link to an edge server corresponding to the application server 504). Similarly, where downlink traffic is received by the network 610 from the application server 504 for transmission to the user device 502, the network 610 may provide the downlink traffic (e.g., via the N6 interface) to the UPF 608, for routing (e.g., via the N3 interface) the downlink traffic to the corresponding base station 606 for transmission to the user device 502.

In other words, the communication link 520(or radio link) between the user device 502 and base station 606 may define the Uu interface for transmitting uplink (or receiving downlink) traffic from a base station 606. The core network 602 may facilitate communication between the base station 606 and application server 504 via the user plane, some of which spans the core network 602, to the Internet and/or to a direct link to an edge server/device corresponding to the application server 504.

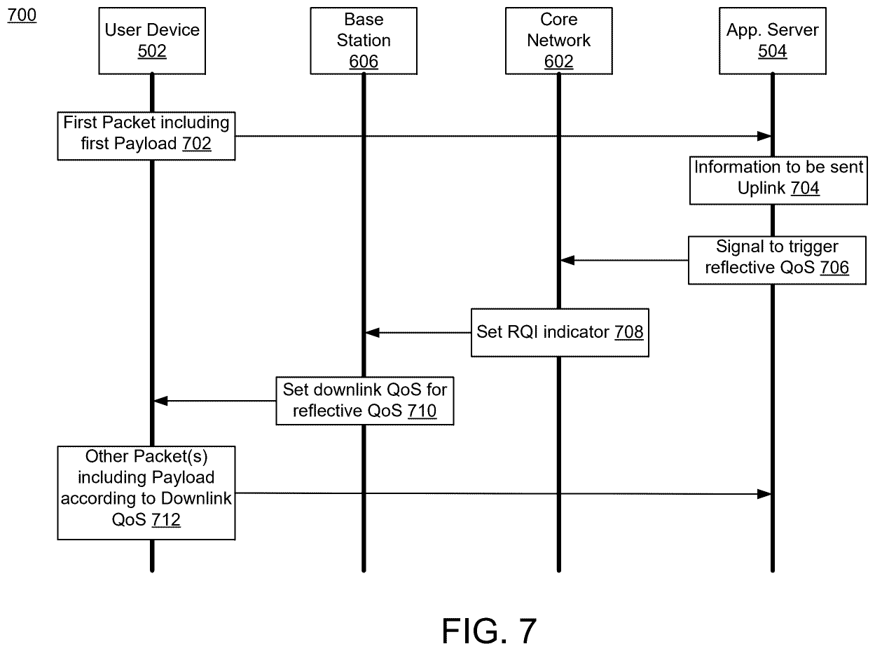

Referring now to FIG. 7, with continued reference to FIG. 5 and FIG. 6, depicted is a diagram showing a process flow 700 of communication with expedited data transfer, according to an example implementation of the present disclosure. As shown in FIG. 7, certain steps of the process flow 700 may be performed by various hardware components described above with reference to FIG. 5-FIG. 6, such as the user device 502, base station 606, core network 602, and application server 504.

In some embodiments, prior to implementation of the process flow 700, the user device 502 may initiate access to the core network 602 to establish a session with the application server 504. For example, the user device 502 may perform a random access procedure to establish a first communication link 520(1) with a base station 606 as described above. In response to the random access procedure, the core network 602 may be configured to establish the data session between the user device 502 and application server 504, including assigning the user device 502 a communication link 520 with various QoS metrics. The core network 602 may be configured to assign the communication link 520 with certain QoS metrics, according to the application which is to use the communication link 520.

At process 702, the user device 502 may be configured to transmit, send, communicate, or otherwise provide a first packet (e.g., with a first payload) via the Uu interface (e.g., the first communication link 520(1), or a default communication link 520(1)) to the base station 606, for routing via the core network 602 to the application server 504. In some embodiments, the first packet may include a small/reduced size payload, a payload which includes information that is not to be analyzed in real-time (e.g., non-real-time information), etc. The user device 502 may be configured to transmit the first packet via the first communication link 520(1) (e.g., defined according to a first 5QI value).

At process 704, the application server 504 (e.g., the application engine 516 of the application server 504) may be configured to determine that information (e.g., a payload) is to be sent uplink (e.g., by the user device 502 to the application server 504). In some embodiments, the application engine 516 may be configured to determine that the payload is to be sent uplink, and that the payload is to include real-time information to be transmitted to the application server 504 (e.g., a video clip, geolocation of the user device 502, or other information which is to be analyzed in substantially real-time by the application server 504).

In some embodiments, the application engine 516 may be configured to determine that the payload is to be sent uplink, based on or according to the first packet (e.g., the first payload in the first packet). For example, the first payload may indicate that the payload in one or more subsequent packets is to include real-time information, such as a video clip, geolocation data, or other types of information that require real-time analysis by the application server 504. The application engine 516 may be configured to analyze the content of the first packet to identify specific markers/flags/fields/indicators which indicate that subsequent packet(s) may leverage real-time analysis. For example, the first packet may include various fields for indicating metrics/information relating to the subsequent packet(s) (e.g., a type of data field for indicating the type of information which is to be sent uplink, a priority level field indicating a priority/urgency of the information which is to be sent uplink, a data size field for indicating a size of the payload of the subsequent packet(s), an application identifier field for indicating an app ID, and so forth). The application engine 516 may be configured to determine that the user device 502 is to send a payload (e.g., including information to be used in substantially real-time) based on the fields indicating the metrics/information relating to the subsequent packet.

In some embodiments, the application engine 516 may be configured to determine that the payload is to be sent uplink, based on or according to the application running on the user device 502 and supported by the application server 504. For instance, certain applications (e.g., the application executing on the user device 502 and supported by the application server 504) may be designed or configured to periodically send real-time information, such as live video feeds, location updates, sensor data, and so forth to the application server 504. The application engine 516 may be configured to determine (e.g., according to the periodicity of the real-time information which is to be sent and the most recent real-time information which was received) that the user device 502 is to send a payload including real-time information to the application server 504.

At process 706, the application server 504 (e.g., the signaling engine 518 of the application server 504) may be configured to communicate, transmit, send, or otherwise provide a signal to trigger a reflective quality of service (QOS) procedure, which is described in greater detail below. In some embodiments, the signaling engine 518 may be configured to send (e.g., using the communication device 512) the signal (via the network 610) to the UPF 608 of the core network 602, to cause the core network 602 to trigger the reflective QoS procedure. In other words, the signaling engine 518 may be configured to send the signal to a wireless communication node 506 (e.g., one or more of the wireless communication nodes 506), to cause the one or more wireless communication nodes to trigger the reflective QoS procedure. The signaling engine 518 may be configured to send the signal to the wireless communication node 506, responsive to the application engine 516 determining that the user device 502 is to send a payload uplink which includes real-time data/information. In other words, the signaling engine 518 may be configured to send the signal to trigger the reflective QoS procedure on a limited basis, based on a determination that real-time information is to be sent uplink by the user device 502.

In some embodiments, the signal may be or include an internet protocol (IP) packet carrying an indication (e.g., an indicator, binary value, flag, etc.) to trigger the reflective QoS procedure. For example, the signaling engine 518 may be configured to generate the IP packet, by configuring the indication in metadata of the IP packet, to request that the core network 602 trigger the reflective QoS procedure. In some embodiments, the signaling engine 518 may be configured to generate the IP packet, to include the indicator and size information (e.g., relating to a number of bits, bytes, etc.) of the payload which is to be sent uplink by the user device. The signaling engine 518 may be configured to determine the size information based on the first packet (e.g., according to a value of the data size field in the first packet) and/or the application which is executing on the user device 502(e.g., according to an average or predetermined size of information which is to be periodically sent by the user device 502).

The signaling engine 518 may be configured to transmit, communicate, send, or otherwise provide the signal downlink via the network 610 to the UPF 608 of the core network 602. For example, responsive to transmitting the signal, the network 610 may transmit (e.g., via the N6 interface) the signal to the UPF 608 of the core network 602 for receipt thereby. In some embodiments, the signaling engine 518 may be configured to provide the signal as part of a packet/data which is sent by the application server 504 to the user device 502. For example, the packet/data may include an acknowledgement of the first packet (e.g., from process 702). As another example, the packet/data may include a request for the user device 502 to transmit packet(s) including the real-time information uplink. As still another example, the packet/data may include other information relating to the application which is to be sent downlink to the user device 502. As yet another example, the packet/data may be or include a dummy packet which carries nonce information and the indicator (e.g., to trigger the reflective QoS procedure).

At process 708, the UPF 608 may be configured to set a reflective QoS (RQI) indicator. The UPF 608 may be configured to set the RQI indicator based on or according to the signal received from the signaling engine 518 of the application server 504. The UPF 608 may be configured to set the RQI indicator, tor trigger use of reflective QoS by the user device 502. In some embodiments, the UPF 608 may be configured to set the RQI indicator in a general packet radio service (GPRS) tunneling protocol (GTP) user plane (GTP-U) header. The GTP-U header may be provided to encapsulate a corresponding packet sent by the application server 504 to the user device 502(e.g., an acknowledgement of the first packet, a request to send the uplink payload, downlink information, dummy packet, and so forth).

The UPF 608 may set the RQI indicator in the GTP-U header, together with the corresponding QoS flow identifier (QFI). The QFI may indicate or otherwise identify a different communication link 520 to use with better QoS metrics than the first communication link 520(1). For example, where the first communication link 520(1) has a 5QI value of 10, the QFI may indicate or otherwise identify to use a QoS flow with a 5QI value of 6 (e.g., the second communication link 520(2)). In other words, the UPF 608 may be configured to set the RQI indicator to trigger the use of reflective QoS by the user device 502, and set the QFI to trigger the use of a better downlink communication link (e.g., a communication link with better QoS metrics) by the base station 606.

The UPF 608 may be configured to transmit, communicate, or otherwise provide the RQI indicator to the base station 606. In some embodiments, the UPF 608 may be configured to provide the GTP-U header (e.g., with the RQI indicator and QFI) to the base station 606 via the N3 interface. In some embodiments, the UPF 608 may be configured to determine which base station 606 to send the RQI indicator, based on various information of the packet/signal received from the application server 504 (e.g., a session identifier, address information, or other identifiers). The UPF 608 may be configured to send the RQI indicator to the base station 606 which is servicing the session between the user device 502 and the application server 504.

At process 710, the base station 606 may be configured to set a downlink QoS for the radio link between the user device 502 and base station 606, according to the GTP-U indicator. For example, the base station 606 may be configured to set the downlink QoS, by sending the packet including the GTP-U header (or a packet which includes information relating to the GTP-U header) to the user device 502 via the Uu interface on the second communication link 520(2) (e.g., the communication link having better QoS metrics than the first communication link 520(1), such as a lower 5QI value). The base station 606 may be configured to send the packet with the RQI indicator to the user device 502, to cause the user device 502 to use the second communication link to perform a reflective QoS procedure for transmitting the payload (e.g., with the real-time information) to the application server 504.

At process 712, the user device 502 may be configured to communicate, send, transmit, or otherwise provide one or more packets including the payload (e.g., with real-time information) to the application server 504 according to the downlink QoS set by the base station 606. For example, the user device 502 may identify that the RQI indicator (or related indicator) in the downlink packet sent by the base station 606 indicates to perform the reflective QoS procedure, and that the downlink packet was sent on the second communication link 520(2) (e.g., with a reduced 5QI value relative to that of the first communication link 520(1)). Based on identifying the RQI indicator and the downlink packet being sent on the second communication link 520(2), the user device 502 may be configured to transmit the one or more packets including the payload via the same communication link 520(2) (e.g., with the reduced 5QI value), thereby reflecting the same QoS on uplink as downlink.

In this regard, the user device 502 may be configured to transfer the packet(s) with the payload including the real-time information with an expedited data transfer, due to the second communication link 520(2) having a lower 5QI value (e.g., and correspondingly, a higher priority/better packet delay budget), as compared to the first communication link 520(1). This results in the packet(s) having the payload being transferred uplink faster than the first packet sent at process 702 (e.g., using the first communication link 520(2)).

In some embodiments, the base station 606 may be configured to monitor a volume of traffic sent uplink by the user device 502, as compared to the size information signaled by the signaling engine 518. The base station 606 may be configured to trigger the user device 502 to revert back to the first communication link 520(1) responsive to the volume of traffic sent uplink meeting and/or exceeding the size information. In this regard, the reflective QoS procedure may support temporary expedited data transfer, according to the signaling provided by the application server 504.

It should be understood that, while described as supporting expedited data transfer uplink by the user device 502, in various embodiments, similar signaling may be provided for downlink traffic (e.g., from the application server 504 via the base station 606 to the user device 502). For example, the application engine 516 may be configured to determine that the application server 504 is to send downlink traffic to the user device which includes a large payload with time-sensitive information. The signaling engine 518 may be configured to transmit a similar signal to the core network 602, to cause the UPF 608 to temporarily improve the QOS metrics of the communication link between the application server 504 to the core network 602.

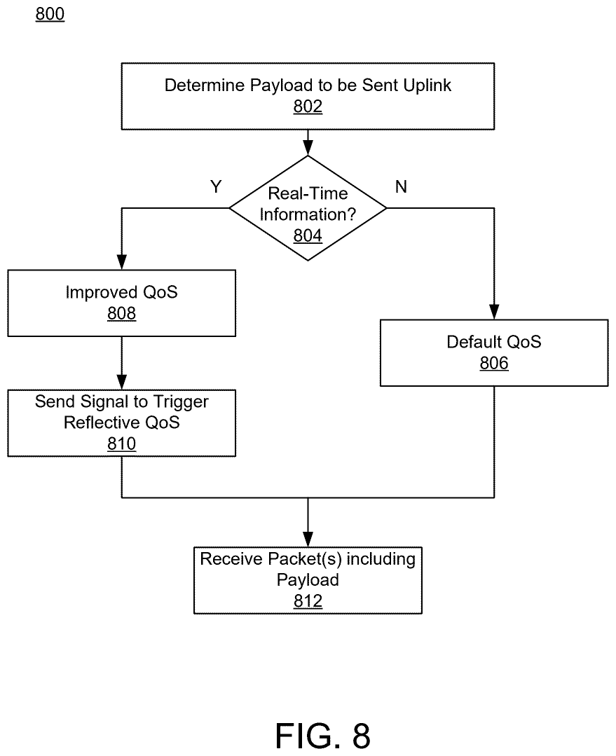

FIG. 8 is a flowchart showing an example method 800 for communication with expedited data transfer, according to an example implementation of the present disclosure. The method 800 may be performed by the elements, components, devices, and/or hardware described above with reference to FIG. 1-FIG. 7, such as the application server 504 (e.g., the processor(s) 508 of the application server 504 and/or the processing engine(s) 514 of the application server 504). As a brief overview, at step 802, the application server may determine that a payload is to be sent uplink. At step 804, the application server may determine whether the payload is to include real-time information. At step 806, the application server may determine to use default QoS for the payload. At step 808, the application server may determine to use improved QoS for the payload. At step 810, the application server may send a signal to trigger a reflective QoS procedure. At step 812, the application server may receive one or more packets including the payload.

At step 802, the application server may determine that a payload is to be sent uplink. In some embodiments, the application server may determine that the payload is to be sent uplink from a user device to the application server. The application server may determine that the payload is to be sent uplink based on a first packet received from the user device, based on an application which is executing on the user device and supported by the application server, and so forth. For example, the application server may receive a first packet (e.g., sent on a first radio link with a first 5QI value from the user device) which indicates or otherwise identifies that the user device is requesting to send a payload uplink to the application server. The application server may determine that the payload is to be sent uplink by the user device based on the first packet. As another example, where the application involves periodic traffic being sent uplink by the user device, the application server may determine that the payload is to be sent uplink by the user device based on a periodicity of the traffic to be sent and a timestamp of the most recently received periodic traffic.

At step 804, the application server may determine whether the payload is to include real-time information. In some embodiments, the application which is supported by the application server may include or involve transmitting payload information which involves real-time (or substantially real-time) analysis by the application server. For example, real-time information may include latency sensitive information, such as video clips to be analyzed by the application server, positioning information of the user device for navigation services, or any other real-time information. Hence, real-time information includes information which is to be analyzed in real-time or substantially real-time. The application server may determine whether the payload is to include real-time information based on the first packet received from the user device and/or based on the information which is to be sent periodically by the user device. For example, where the determination is based on the first packet, the first packet may include a field which indicates a type of information/data which is to be sent uplink. The application server may determine the payload is to include real-time information based on whether the field has a value which matches a set of values that corresponds to real-time information. As another example, where the determination is based on the information which is to be sent periodically, the application server may determine which type of information is scheduled to be sent uplink, and whether that type of information matches types of information that corresponds to real-time information.

Where, at step 804, the application server determines that the payload is to include information other than real-time information, the method 800 may proceed to step 806, where the application server determines to use the default QoS for the payload. For example, by determining to use the default QoS for the payload, the application server may forego signaling any change in the QoS for the radio link between the user device and base station. In other words, when the application server determines to use the default QoS for the payload, the user device may send the payload uplink in one or more packets using default QoS settings (e.g., a first communication link, such as the first communication link which was used for transmitting the first packet described above).

Where, at step 804, the application server determines that the payload is to include real-time information, the method 800 may proceed to step 808. At step 808, the application server may determine to use improved QoS for the payload. The application server may determine to user the improved QoS for the payload, to cause an expedited data transfer from the user device via the core network to the application server.

At step 810, the application server may send a signal to trigger a reflective QoS procedure. In some embodiments, the application server may send the signal to a wireless communication node, to cause the wireless communication node to trigger a reflective quality of service (QOS) procedure by the user device for transmitting the payload to the application server. The application server may send the signal responsive to determining that the payload is to include real-time information (e.g., at step 808).

In some embodiments, the signal comprises an internet protocol (IP) packet carrying an indication to trigger the reflective QoS procedure. For example, the application server may generate the signal as an IP packet (e.g., an acknowledgement of the first packet from the user device, a request for the real-time information, or any other IP packet), which includes an indicator that triggers the reflective QoS procedure. In some embodiments, the indicator may be or include a binary indicator (e.g., carried in a header of the IP packet, metadata of the IP packet, or in any other field of the IP packet) which indicates (e.g., to the core network) to trigger the reflective QoS procedure according to a value of the binary indicator. For example, where the binary indicator is set to “1” or high, the binary indicator may indicate to trigger the reflective QoS procedure whereas, if the binary indicator is set to “0” or low, the binary indicator may indicate to forego triggering the reflective QoS procedure. In one or more implementations of this example, where at step 806, the application server determines to use a default QoS for the payload, the application server may set the binary indicator in a corresponding IP packet to “0”.

In some embodiments, the signal causes the wireless communication node to configure a 5G QoS indicator (5QI) value via a user plane function (UPF) for a downlink channel. For example, the application server may transmit the signal (e.g., using the N6 interface) to the UPF. The UPF, upon receive of the signal, may configure a general packet radio service (GPRS) tunneling protocol (GTP) user plane (GTP-U) header (e.g., for the IP packet received from the application server) with a reflective QoS (RQI) indicator and a corresponding QoS flow identifier (QFI) which indicates the 5QI value which is to be configured. The UPF may communicate the GTP-U header with the RQI indicator and QFI to the wireless communication node which is servicing the user device. The wireless communication node may configure the radio link which is to be used to send the IP packet downlink to the user device, according to the 5QI value. The wireless communication node may send the IP packet downlink to the user device, with the RQI indicator (or some other indicator) to indicate that the user device is to perform reflective QoS for transmitting packet(s) uplink.

The user device may transmit the payload (e.g., via one or more packets) uplink via the base station to the application server, according to the 5QI value in which the IP packet was sent downlink (e.g., when the RQI indicator indicates to perform reflective QoS). In this regard, the user device may perform the reflective QoS procedure, to transmit the payload uplink to the application server using improved QoS values. For example, where first packet(s) were transmitted by the user device according to a default QoS (e.g., a communication link with a first 5QI value), the user device may transmit other packet(s) with payload(s) including real-time information according to the improved QoS (e.g., a communication link with a second 5QI value that corresponds to a higher priority level, reduced packet delay budget, etc. as compared to the first 5QI value).

At step 812, the application server may receive one or more packets including the payload. The application server may receive the packet(s) including the payload, responsive to transmitting the signal which causes the wireless communication node to trigger the reflective QoS procedure with the improved 5QI value. The application server may receive the packet(s) including the payload, according to the reflective QoS procedure, to expedite data transfer uplink from the user device to the application server (e.g., on demand) according to the signal sent to the core network.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
determining, by an application server, a payload is to be sent uplink from a user device to the application server;
sending, by the application server to a wireless communication node, a signal to cause the wireless communication node to trigger a reflective quality of service (QOS) procedure by the user device for transmitting the payload to the application server; and
receiving, by the application server, from the user device via the wireless communication node, one or more packets including the payload according to the reflective QoS procedure.

2. The method of claim 1, wherein the signal comprises an internet protocol (IP) packet carrying an indication to trigger the reflective QoS procedure.

3. The method of claim 1, wherein the signal causes the wireless communication node to configure a 5G QoS indicator (5QI) value via a user plane function (UPF) for a downlink channel, to cause the user device to use the 5QI value for transmitting the one or more packets including the payload uplink, according to the reflective QoS procedure.

4. The method of claim 1, wherein the one or more packets comprise one or more second packets, the method further comprising receiving, by the application server from the user device, a first packet according to a first 5G QOS indicator (5QI) value.

5. The method of claim 4, wherein the application server determines that the payload is to be sent uplink from the user device according to the first packet.

6. The method of claim 4, wherein the first 5QI value is different than a second 5QI value triggered by the wireless communication node according to the reflective QoS procedure and in which the application server receives the one or more second packets.

7. The method of claim 1, wherein the application server determines that the user device is to send the payload uplink to the application server, according to an application running on the user device and supported by the application server.

8. The method of claim 7, wherein the application supports real-time information transmission from the user device to the application server.

9. The method of claim 1, wherein the signal comprises a binary indicator indicating to trigger the reflective QoS procedure, according to a value of the binary indicator.

10. A system, comprising:
an application server including one or more processors configured to:
determine a payload is to be sent uplink from a user device to the application server;
send, via a transmitter to a wireless communication node, a signal to cause the wireless communication node to trigger a reflective quality of service (QOS) procedure by the user device for transmitting the payload to the application server; and
receive, via a receiver from the user device, one or more packets including the payload according to the reflective QoS procedure.

11. The system of claim 10, wherein the signal comprises an internet protocol (IP) packet carrying an indication to trigger the reflective QoS procedure.

12. The system of claim 10, wherein the signal causes the wireless communication node to configure a 5G QoS indicator (5QI) value via a user plane function (UPF) for a downlink channel, to cause the user device to use the 5QI value for transmitting the one or more packets including the payload uplink, according to the reflective QoS procedure.

13. The system of claim 10, wherein the one or more packets comprise one or more second packets, and wherein the one or more processors are configured to receive, via the receiver from the user device, a first packet according to a first 5G QoS indicator (5QI) value.

14. The system of claim 13, wherein the application server determines that the payload is to be sent uplink from the user device according to the first packet.

15. The system of claim 13, wherein the first 5QI value is different than a second 5QI value triggered by the wireless communication node according to the reflective QoS procedure and in which the application server receives the one or more second packets.

16. The system of claim 10, wherein the one or more processors are configured to determine that the user device is to send the payload uplink to the application server, according to an application running on the user device and supported by the application server.

17. The system of claim 16, wherein the application supports real-time information transmission from the user device to the application server.

18. The system of claim 10, wherein the signal comprises a binary indicator indicating to trigger the reflective QoS procedure, according to a value of the binary indicator.

19. A non-transitory computer readable medium storing instructions that, when executed by one or more processors of an application server, cause the application server to:
determine a payload is to be sent uplink from a user device to the application server;
send, via a transmitter to a wireless communication node, a signal to cause the wireless communication node to trigger a reflective quality of service (QOS) procedure by the user device for transmitting the payload to the application server; and
receive, via a receiver from the user device, one or more packets including the payload according to the reflective QoS procedure.

20. The non-transitory computer readable medium of claim 19, wherein the signal causes the wireless communication node to configure a 5G QoS indicator (5QI) value via a user plane function (UPF) for a downlink channel, to cause the user device to use the 5QI value for transmitting the one or more packets including the payload uplink, according to the reflective QOS procedure.
